(19) United States
(12) Patent Application Publication
(10) Pub. No.: US 2019/0326054 A1
(43) Pub. Date: Oct. 24, 2019

(54) METHOD FOR PRODUCING RARE EARTH MAGNET

(71) Applicant: TDK Corporation, Chuo-ku, Tokyo (JP)

(72) Inventors: Kenichi SUZUKI, Chuo-ku, Tokyo (JP); Osamu OHHATA, Chuo-ku, Tokyo (JP); Akihiro OHSAWA, Chuo-ku, Tokyo (JP)

(73) Assignee: TDK Corporation, Chuo-ku, Tokyo (JP)

(21) Appl. No.: 16/347,622

(22) PCT Filed: Nov. 7, 2017
(86) PCT No.: PCT/JP2017/040098

§ 371 Date: May 6, 2019

(30) Foreign Application Priority Data
Nov. 9, 2016 (JP) 2016-218928

(51) Int. Cl. H01F 41/02; H01F 1/053

(52) U.S. Cl. CPC H01F 41/0266; B22F 9/04; H01F 1/0536

(57) ABSTRACT

A method for producing a rare earth magnet includes a molding step of supplying a metal powder including a rare earth element into a mold 2 to form a green compact 10; an orientation step of applying a pulse magnetic field H to the green compact 10 held in the mold 2 to orient the metal powder included in the green compact 10; and a sintering step of sintering the green compact 10 separated from the mold 2 after the orientation step. At least one part of the mold 2 is formed from a resin, and the green compact having a density adjusted to 3.0 g/cm³ or more and 4.4 g/cm³ or less is sintered.

### TECHNICAL FIELD

The present invention relates to a method for producing a rare earth magnet.

### BACKGROUND ART

Rare earth magnets are components of motors, actuators, and the like, and used in various fields such as hard disk drives, hybrid vehicles, electric vehicles, magnetic resonance imaging apparatuses (MRI), smartphones, digital cameras, flat-screen TVs, scanners, air conditioners, heat pumps, refrigerators, vacuum cleaners, washing and drying machines, elevators, and wind power generators, for example. The dimensions and shape required for the rare earth magnets vary depending on these various intended uses. Thus, in order to efficiently produce various kinds of rare earth magnets, a molding method is desired which is capable of easily changing the dimensions and shapes of the rare earth magnets.

In the production of a conventional rare earth magnet, a magnetic field is applied to a metal powder while pressurizing a metal powder (for example, an alloy powder) containing a rare earth element at a high pressure (for example, 50 MPa or more and 200 MPa or less). As a result, a green compact is formed from the metal powder oriented along the magnetic field. Such a molding method will be referred to as a “high-pressure magnetic field pressing method” below. According to the high-pressure magnetic field pressing method, metal powder is easily oriented and it is possible to obtain a green compact having a high residual magnetic flux density Br and an excellent shape retaining ability. A sintered body is obtained by sintering the green compact, and the sintered body is processed into a desired shape, thereby providing a completed magnet product.

However, in the high-pressure magnetic field pressing method, it is necessary to exert a high pressure on the metal powder in the magnetic field, thus requiring a large-scale and complicated molding apparatus, and the dimensions and shape of the metallic mold for molding are restricted. Because of this restriction, the shapes of common green compacts obtained by the high-pressure magnetic field pressing method are limited to coarse blocks. Accordingly, in the case of producing various kinds of magnet products by a conventional method, it is necessary to process the sintered bodies in accordance with the dimensions and shapes required for the magnet products after the sintered bodies are obtained by making block-shaped green compacts sintered. In processing the sintered bodies, the sintered bodies are cut or polished, and scraps containing expensive rare earth elements are thus produced. As a result, the yield rates of the magnet products are decreased. In addition, in the high-pressure magnetic field pressing method, the metallic molds or green compacts are likely to be broken due to galling between the metallic molds or galling between the metallic mold and the green compact. For example, cracks are occasionally generated in the green compacts obtained by the high-pressure magnetic field press method.

For the reasons as mentioned above, the method for production with the use of the conventional high-pressure magnetic field pressing method is not suitable for the production of various kinds or small amounts of magnet products. As a molding method in place of the high pressure magnetic field pressing method, Patent Document 1 below discloses a method of molding an alloy powder at low pressure (0.98 MPa or more and 2.0 MPa or less). This method for manufacturing a rare earth magnet includes a step (filling step) of preparing a green compact by filling a mold with an alloy powder and then pressurizing the alloy powder at a low pressure, a step (orientation step) of orienting the alloy powder in the green compact by applying a magnetic field to the green compact in the mold, and a step (sintering step) of sintering the green compact removed from the mold. In the production method described in Patent Literature 1 below, the filling step and the orientation step are conducted in different places.

### CITATION LIST

### Patent Literature

Patent Literature 1: International Publication No. 2016/047593

### SUMMARY OF INVENTION

### Technical Problem

In the case of molding a metal powder at low pressure as in the molding method described in Patent Document 1, durability against high pressures is not required for the metallic mold, and a large-scale and complicated molding apparatus is also unnecessary. Accordingly, in the case of molding a metal powder at a low pressure, the material, dimensions, and shape of the metallic mold are not restricted and it is possible to produce various kinds of rare earth magnets in a relatively easy way with the use of molds having various dimensions and shapes. In addition, the high-pressure magnetic field pressing method requires a long period of time for molding and orienting the metal powder, but molding the metal powder at a low pressure greatly shortens the time required for molding and orienting, thereby improving the productivity of the rare earth magnet.

However, in the molding method described in the document Patent Literature 1, a pulse magnetic field is applied to a metal powder located in a mold made of an electroconductor such as a metal or carbon. Thus, an eddy current flows in the mold to generate a reverse magnetic field. When such a reverse magnetic field is generated near a surface of the mold that contacts the metal powder (inner wall of the mold), the metal powder constituting the green compact is pulled to the mold surface by the reverse magnetic field. Accordingly, the center of the green compact becomes sparse occasionally. In the case of sintering a green compact having an uneven density due to a reverse magnetic field in such a way, the resultant sintered body (rare earth magnet) may easily be cracked. Moreover, the reverse magnetic field generated by the eddy current disturbs the orientation of the metal powder, thus magnetic properties of the rare earth magnet may be deteriorated. Furthermore, when a magnetic field is applied to a mold made of an electroconductor, the eddy current loss causes the mold to generate heat, or an instantaneous impact (magnetic force) acts on the mold itself. As a result, the mold is easily wasted.

Moreover, as a result of researches made by the inventors, it turned out that rare earth magnets produced by use of the molding method described in the document Patent Literature 1 do not necessarily have a sufficient residual magnetic flux density Br. Moreover, it turned out that in the case of producing a rare earth magnet using the molding method described in the document Patent Literature 1, the rare earth magnet is easily cracked.

The present invention has been made in view of the foregoing problem of the prior art, and an object of the inventions is to provide a method for producing a rare earth magnet, which suppresses eddy currents in a mold when a metal powder containing a rare earth element is oriented in the mold, and improves residual magnetic flux density of the rare earth magnet, and suppresses cracks in the rare earth magnet.

### Solution to Problem

A method for producing a rare earth magnet according to an aspect of the present invention includes a molding step of supplying a metal powder containing a rare earth element into a mold to form a green compact; an orientation step of applying a pulse magnetic field to the green compact held in the mold to orient the metal powder included in the green compact; and a sintering step of sintering the green compact separated from the mold after the orientation step. In this method, at least one part of the mold is formed from a resin, and the green compact having a density adjusted to 3.0 g/cm³ or more and 4.4 g/cm³ or less is sintered.

In an aspect of the present invention, the mold includes a lower mold, a cylindrical side mold to be disposed on the lower mold, and an upper mold to be inserted into the side mold from above the side mold; and out of the lower mold, the side mold and the upper mold, at least the side mold is formed from the resin.

In an aspect of the present invention, the resin may be an insulating resin.

In an aspect of the present invention, a pressure exerted on the metal powder by the mold may be adjusted to 0.049 MPa or more and 20 MPa or less.

In the orientation step, the pulse magnetic field may be applied to the green compact, using at least two coils arranged to have the same central axis.

### Advantageous Effects of Invention

The present invention provides a method for producing a rare earth magnet, which suppresses eddy currents in a mold when a metal powder containing a rare earth element is oriented in the mold, and improves residual magnetic flux density of the rare earth magnet, and suppresses cracks in the rare earth magnet.

### BRIEF DESCRIPTION OF DRAWINGS

FIG. 1 is a schematic perspective view of a mold (an upper mold, a side mold and a lower mold) used in a molding step.

FIG. 2 is a schematic sectional view of an air-core coil, the mold located in the air-core coil, and a green compact held by the mold.

FIG. 3 is a chart showing an example of a pulse magnetic field to be applied to the green compact in a molding step.

FIG. 4 is a schematic perspective view of the air-core coil, the mold located in the air-core coil, and the green compact held by the mold.

FIG. 5 is a chart showing an arrangement of the air-core coil, the mold and the green compact in a simulation of an orientation step.

FIG. 6 is an enlarged view of FIG. 5.

FIG. 7 is another enlarged view of FIG. 5.

FIG. 8 is a circuit diagram showing a magnetic field orienting apparatus having the air-core coil.

FIG. 9 is a chart an attenuated waveform of an alternating current flowing in the air-core coil in the orientation step.

FIG. 10 is a chart showing the transition of a magnetic force acting on each part of a green compact in an orientation step of Example 1.

FIG. 11 is a chart showing the respective transitions of magnetic flux density acting on a central part of the green compact in the orientation step of Example 1, and an eddy current flowing in a mold therein.

FIG. 12 is a chart showing the transition of a magnetic force acting on each part of a green compact in an orientation step of Comparative Example 1.

FIG. 13 is a chart showing the respective transitions of magnetic flux density acting on a central part of the green compact in the orientation step of Comparative Example 1, and an eddy current flowing in a mold therein.

FIG. 14 is a chart showing a magnetic force acting on each part of the green compact positioned on an axis r in FIG. 7 in the orientation step of each of Example 1 and Comparative Example 1.

FIG. 15 is a schematic perspective view of a magnetic field orienting apparatus having a pair of coils (double coil).

### DESCRIPTION OF EMBODIMENTS

With reference to the drawings, a preferred embodiment of the present invention will be described in detail below. In the drawings, the same or similar signs are attached to the same or similar constituents. The present invention is not limited to the embodiment. In each of the figures, X, Y and Z denote three coordinate axes orthogonal to each other. The direction shown by each of the coordinate axes is common to all the figures.

The rare earth magnet means a sintered magnet in the present embodiment. In the method for the rare earth magnet, an alloy is first cast. The casting method may be, for example, a strip casting method. The alloy may have a flake or ingot form. The alloy contains a rare earth element R. The rare earth element R may be at least one element selected from the group consisting of La, Ce, Pr, Nd, Pm, Sm, Eu, Gd, Th, Dy, Ho, Er, Tm, Yb, and Lu. The raw material alloy may contain at least one element selected from the group consisting of B, N, Fe, Co, Cu, Ni, Mn, Al, Nb, Zr, Ti, W, Mo, V, Ga, Zn, Si, and Bi in addition to the rare earth element R. The chemical composition of the alloy may be adjusted depending on the chemical compositions of the main phase and grain boundary phase of the rare earth magnet desired to be finally obtained. In other words, raw materials for the alloy may be prepared by weighing and blending respective starting materials containing the above-mentioned elements depending on the composition of the target rare earth magnet. The rare earth magnet may be, for example, a neodymium magnet, a samarium cobalt magnet, a samarium-iron-nitrogen magnet, or a praseodymium magnet. The main phase of the rare earth magnet may be, for example, Nd₂Fe₁₄B, SmCo₅, Sm₂Co₁₇, Sm₂Fe₁₇N₃, Sm₁Fe₇Nₓ, or PrCo₅. The grain boundary phase may be, for example, a phase (R-rich phase) in which the content of the rare earth element R is higher as compared with the main phase. The grain boundary phase may include a B-rich phase, an oxide phase, or a carbide phase.

A coarse alloy powder is obtained by pulverizing the above-mentioned alloy coarsely. In the coarse pulverizing, for example, the alloy may be pulverized by hydrogen storage in the grain boundary (R-rich phase) of the alloy. In the coarse pulverizing for the alloy, a mechanical pulverizing method may be used, such as a disk mill, a jaw crusher, a Braun mill, or a stamp mill. The particle diameter of the coarse powder obtained by the coarse pulverizing may be, for example, 10 μm or more and 100 μm or less.

A fine powder of the alloy is obtained by pulverizing the coarse powder finely. In fine pulverizing, the alloy powder may be pulverized by a jet mill, a ball mill, a vibration mill, a wet attritor, or the like. The particle diameter of the fine powder obtained by the fine pulverizing may be, for example, 0.5 μm or more and 5 μm or less. Hereinafter, the coarse powder or the fine powder may be referred to as an alloy powder or a metal powder in some cases.

Organic substances may be added to the alloy powder obtained by the coarse pulverizing. Organic substances may be added to the fine powder obtained by the fine pulverizing. In other words, organic substances may be mixed with the metal powder either before or after the fine pulverizing. The organic substances function, for example, as a lubricant. The addition of the lubricant to the metal powder. The addition of the lubricant to the metal powder suppresses aggregation of the metal powder. In addition, the addition of the lubricant to the metal powder easily reduces the friction between the mold and the metal powder in a subsequent step. As a result, the metal powder is easily oriented in an orientation step, and damages are easily suppressed at the surface of a green compact obtained from the metal powder or the surface of the mold. The organic substances may be, for example, a fatty acid or a derivative of a fatty acid. The organic substance may be, for example, at least one selected from the group consisting of an oleic acid amide, a zinc stearate, a calcium stearate, a stearic acid amide, a palmitic acid amide, a pentadecyl acid amide, a myristic acid amide, a lauric acid amide, a capric acid amide, a pelargonic acid amide, a caprylic acid amide, an enanthic acid amide, a caproic acid amide, a valeric acid amide, and a butyric acid amide. The lubricant may be a powdery organic substance. The lubricant may be a liquid organic substance. An organic solvent in which a powdery lubricant is dissolved may be added to the alloy powder.

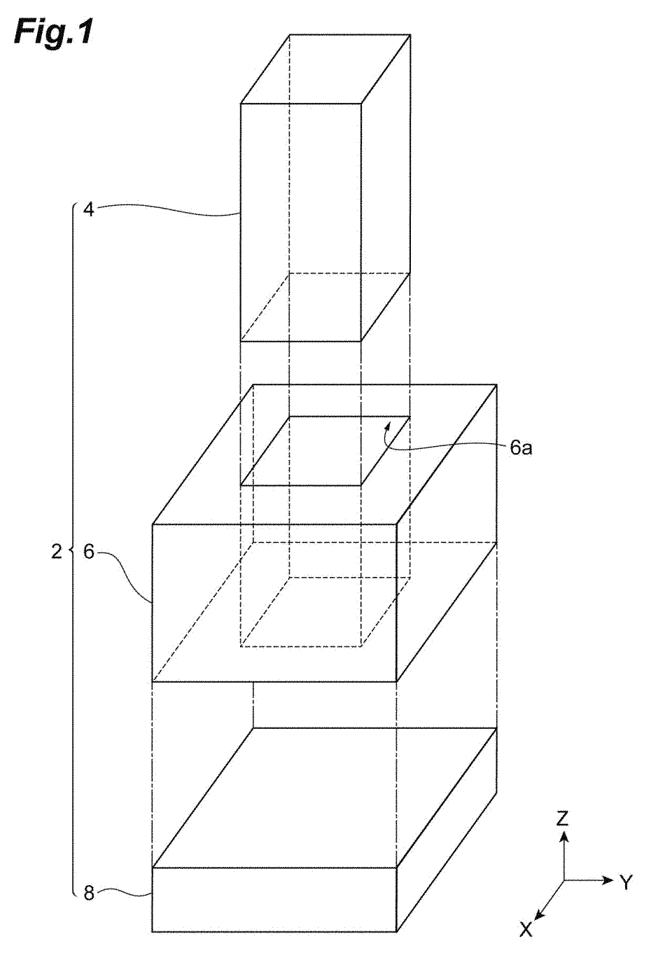

In a molding step, the alloy powder obtained in accordance with the above-mentioned procedure is fed into the mold to form a green compact. A part or the whole of the mold is formed from a resin. As illustrated in, for example, FIG. 1, the mold 2 includes, for example, a lower mold 8, a cylindrical side mold 6 disposed on the lower mold 8, and an upper mold 4 (punch) disposed on the side mold 6. A space corresponding to the shape and dimensions of the rare earth magnet penetrates the side mold 6 in the vertical direction. The side mold 6 may be paraphrased as a side wall of the mold 2. The lower mold 8 may have a plate form. The position of the side mold 6 in the horizontal direction may be fixed by fitting a lower part of the side mold 6 to the stops formed on the surface of the lower mold 8. In the molding step, the side mold 6 is placed on the lower mold 8, and the opening (hole) of the side mold 6 on the lower side is closed by the lower mold 8. With such a configuration, the side mold 6 and the lower mold 8 constitute a cavity (female mold). Subsequently, the alloy powder is introduced into the cavity from the opening (hole) on the upper side of the side mold 6. As a result, the alloy powder is molded in the cavity so as to correspond to the shape and dimensions of the rare earth magnet. The alloy powder may be adapted to fill the cavity. In other words, the cavity may be filled with the alloy powder.

The upper mold 4 may be paraphrased as a core (male mold). The upper mold 4 may have a shape fitting into the cavity. The upper mold 4 may be inserted into the cavity. The green compact 10 (alloy powder) in the cavity may be compressed by the end surface of the upper mold 4. However, the density of the green compact 10 sufficiently increases only by sintering the alloy powders in a sintering step, thereby providing a rare earth magnet with a desired density, and thus, it is not necessary to compress the alloy powder in the cavity.

In the molding step, the pressure exerted on the alloy powder by the mold may be adjusted to 0.049 MPa or more and 20 MPa or less (0.5 kgf/cm² or more and 200 kgf/cm² or less). The pressure may be, for example, the pressure exerted by the end surface of the upper mold 4 on the alloy powder. As just described, forming a green compact 10 from the alloy powder at a lower pressure than in a conventional high-pressure magnetic field pressing method easily reduces the friction between the mold 2 and the green compact 10, and easily suppresses breakages of the mold 2 or green compact 10 (for example, cracks in the green compact 10). If the pressure is excessively high, the mold 2 bends, it is difficult to secure the target capacity of the cavity, and it is difficult to obtain the target density of the green compact 10. In the conventional high-pressure magnetic field pressing method, it has been necessary to simultaneously mold and orient the alloy powder under high pressure. On the other hand, according to the present embodiment, it is unnecessary to conduct the molding and the orienting simultaneously, and the orientation step can be conducted after the molding step. Separating the molding step and the orientation step makes it possible to use smaller and more inexpensive apparatuses (for example, a press molding apparatus and a magnetic field applying apparatus) for each step than conventional apparatuses. The molding step and the orientation step may be conducted almost simultaneously.

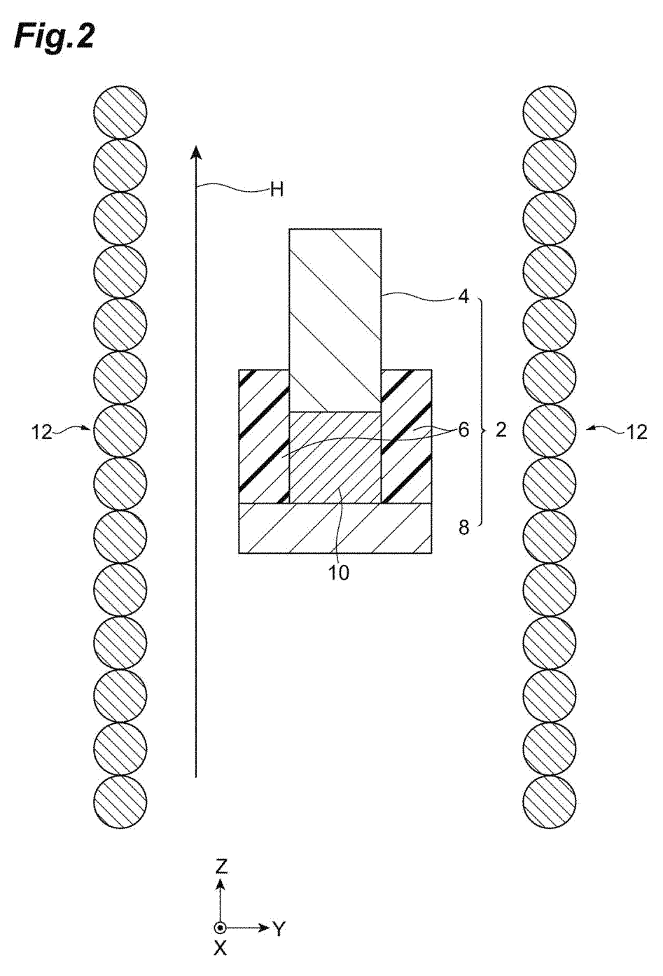

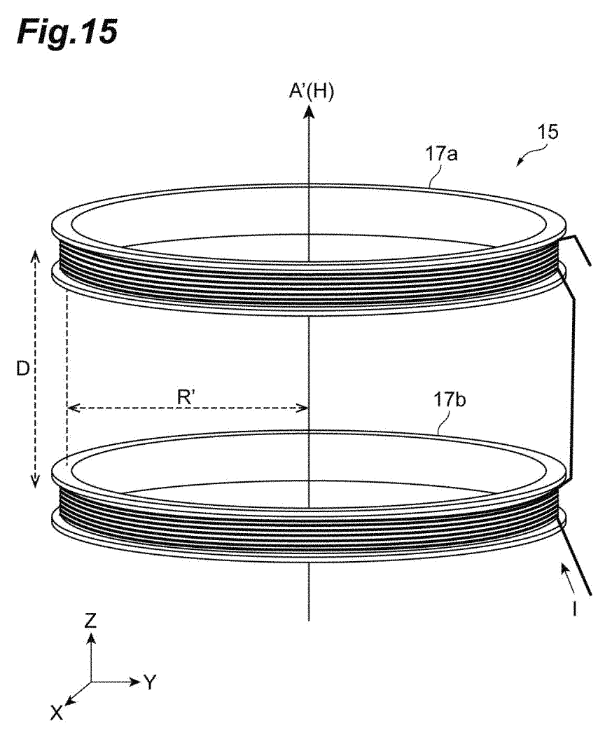

In the orientation step, a pulse magnetic field is applied to the green compact 10 held in the mold 2 to orient the alloy powder constituting the green compact 10 inside the mold 2 along the pulse magnetic field. As illustrated in, for example, FIG. 2, the green compact 10 held in the mold 2 is located, together with the mold 2, inside an air-core coil 12 (solenoid coil) (for example, at the center of the air-core coil 12). By causing a current to flow in the air-core coil 12, a pulse magnetic field H may be applied to the green compact 10 in the mold 2. The number of times of applying the pulse magnetic field H to the green compact 10 may be one time or plural times. Two or more coils may be used to apply the magnetic field H to the green compact 10 in the mold 2. The pulse magnetic field H may be applied to the green compact 10 in the mold 2, for example, by locating the green compact 10, together with the mold 2, inside a double coil or Helmholtz coil, and causing a current to flow in the double coil or Helmholtz coil. The magnetic field generating apparatus may have a double coil instead of the air-core coil 12. As illustrated in FIG. 15, a double coil 15 is two coils 17a and 17b arranged to have the same central axis A′. The two coils 17a and 17b may have the same radius R′ (inner diameter). One coil 17a and the other coil 17b may be exactly the same coils. The two coils 17a and 17b may be arranged in parallel with a flat plane perpendicular to the central axis A′. One coil 17a may overlap with the other coil 17b when the two coils are viewed along a direction parallel with the central axis A′. In other words, the two coils 17a and 17b may be straightly arranged when viewed along the direction parallel with the central axis A′. The respective magnitudes and the respective directions of the currents I flowing in the two coils 17a and 17b may be the same. The distance D between each center of one coil 17a and the other coil 17b may be different from the radius R′ of each of the coils 17a and 17b. When the distance D is equal to the radius R′, the double coil 15 is a Helmholtz coil. In a central part of a space sandwiched between the two coils 17a and 17b described above, the uniform pulse magnetic field H is easily generated. The use of the double coil or Helmholtz coil makes it possible to apply more uniform pulse magnetic field H to the green compact 10 compared with the case of using air-core coil. As a result, the orientation of the alloy powder in the green compact 10 is easily improved and magnetic properties of the finally obtained rare earth magnet are improved. A magnetizing yoke may be used to apply the pulse magnetic field H to the green compact 10 in the mold. A pulse magnetic field H generated by the air-core coil 12 and another coil may be applied to the green compact 10 in the mold 2. A pulse magnetic field H generated by the double coil 15 and another coil may be applied to the green compact 10 in the mold 2. A pulse magnetic field H generated by the air-core coil 12 and the double coil 15 may be applied to the green compact 10 in the mold 2. Two or more coils may be arranged obliquely along the same central axis.

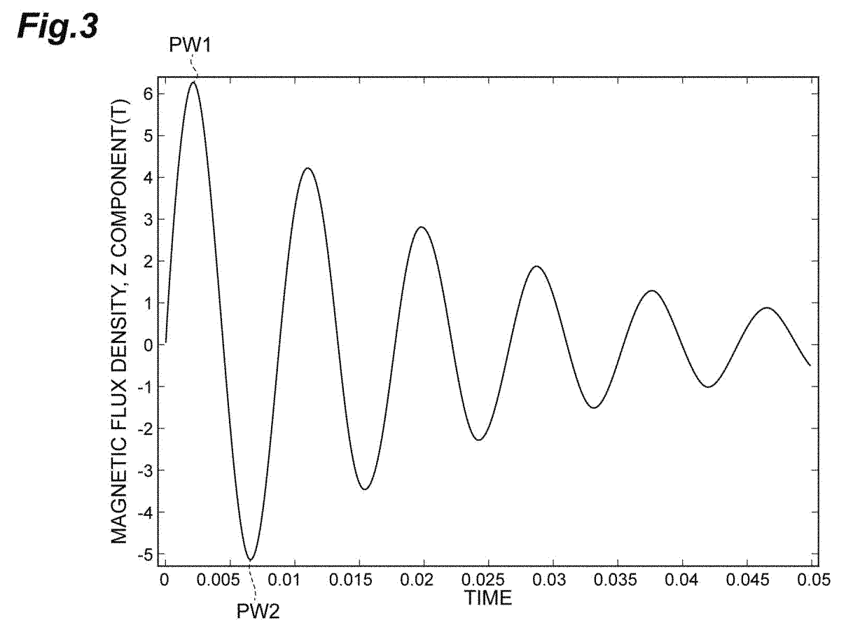

The pulse magnetic field H may be an alternating magnetic field. In other words, the pulse magnetic field H may be a magnetic field where change in its intensity and direction is repeated with the passage of time. The pulse magnetic field H may be an attenuated alternating magnetic field. In other words, the pulse magnetic field H may be attenuated while repeatedly reversing with the passage of time. An example of the pulse magnetic field H is shown in FIG. 3. A vertical axis in FIG. 3 shows the magnetic flux density (unit: T) of the pulse magnetic field H, and a transverse axis in FIG. 3 shows time (unit: seconds). As shown in FIG. 3, the maximum intensity (amplitude) of a pulse wave (first pulse wave PW1) of a magnetic field applied firstly to the green compact 10 may be larger than the maximum intensity of a pulse wave (second pulse wave PW2) of a magnetic field applied to the green compact 10 subsequently to the first pulse wave PW1. The direction of the second pulse wave PW2 may be reverse to that of the first pulse wave PW1. The alloy powder constituting the green compact 10 may be oriented by the application of the first pulse wave PW1, and the green compact 10 may be degaussed by the application of the second pulse wave PW2. The method for generating the alternating magnetic field may be an alternate current method or a direct current inverting method.

The intensity of the pulse magnetic field H applied to the green compact 10 in the mold 2 may be, for example, 796 kA/m or more and 5173 kA/m or less (10 kOe or more and 65 kOe or less), or 2387 kA/m or more and 3979 kA/m or less (30 kOe or more and 50 kOe or less). When the intensity of the pulse magnetic field H is 796 kA/m or more, the alloy powder is sufficiently improved in orientation with ease. As the orientation of the alloy powder is higher, the residual magnetic flux density of the resultant rare earth magnet is easily heightened. If the intensity of the pulse magnetic field H is more than 5173 kA/m, the orientation of the alloy powder is not easily improved even when the intensity of the pulse magnetic field H is increased. Moreover, if the intensity of the pulse magnetic field H is more than 5173 kA/m, a large magnetic field generating apparatus is necessary and costs required for the orientation step increase. The intensity of the pulse magnetic field to be applied to the green compact 10 in the mold 2 is not necessarily limited to the above-mentioned range.

The duration time of the pulse magnetic field H may be, for example, 10 μseconds or longer and 0.5 seconds or shorter. The duration time of the pulse magnetic field H is a period from a time when the application of the pulse magnetic field H to the green compact 10 is started to a time when the application is ended. When the duration time of the pulse magnetic field H is 10 μseconds or longer, the orientation of the alloy powder is heightened sufficiently and easily. As the duration time of the pulse magnetic field H is longer, the amount of generated heat becomes larger in the air-core coil 12 for generating the pulse magnetic field H, thus electric power tends to be further wasted. The cycle of the first pulse wave PW1 applied firstly to the green compact 10 as the pulse magnetic field H may be, for example, 0.01 milliseconds or longer and 100 milliseconds or shorter, and preferably 1 milliseconds or longer and 30 milliseconds or shorter. When the cycle of the first pulse wave PW1 is in the above ranges, rotations of respective particles of the alloy powder easily follow the application of the pulse magnetic field H, thus the alloy powder is easily oriented. As a result, magnetic properties (for example, residual magnetic flux density) of the finally obtained rare earth magnet are easily improved. Even in the case of using any one of an alloy powder with high fluidity and an alloy powder with low fluidity, there is a tendency that the orientation of the alloy powder is improved and the residual magnetic flux density of the rare earth magnet are heightened as the cycle of the first pulse wave PW1 is shorter.

The mold 2 occasionally moves inside the air-core coil 12 by an impact following the application of the pulse magnetic field H. The movement of the mold 2 may cause a gap in the mold 2 and the alloy powder occasionally leaks from the gap. Thus, in order to suppress the movement of the mold 2, the mold 2 located in the air-core coil 12 may be fixed with a tool.

The pulse magnetic field H has a higher magnetic field intensity than static magnetic fields used frequently in the conventional high-pressure magnetic field pressing method, and the pulse magnetic field H is applied to the green compact 10 in a short period. Accordingly, owing to the orientation step using the pulse magnetic field H, the green compact 10 with high orientation degree is obtained in a shorter period compared with the case of using a static magnetic field, and a rare earth magnet with high residual magnetic flux density is produced as the result. However, in the case of applying the pulse magnetic field H to the green compact 10 held in a mold composed of an electroconductor (for example, a metal), the intensity of the magnetic field acting on the mold is rapidly changed in a shorter period than in the case of applying a static magnetic field thereto. Consequently, an eddy current easily flows in the mold by electromagnetic induction and a reverse magnetic field is easily generated. However, in the present embodiment, a part or the whole of the mold 2 is formed from a resin. Accordingly, when the pulse magnetic field H is applied to the metal powder located in the mold 2, an eddy current hardly flows in the mold 2, and a reverse magnetic field is hardly generated. This matter suppresses a phenomenon that the metal powder constituting the green compact 10 is pulled to the surface of the mold 2 by the reverse magnetic field. As a result, the density of the green compact 10 is easily made uniform, thus a sintered body (rare earth magnet) in the sintering step is hardly cracked. Moreover, owing to suppressing the eddy currents and the reverse magnetic field in the orientation step, the orientation of the metal powder is improved and magnetic properties of the rare earth magnet are improved. Furthermore, since a part or the whole of the mold 2 is formed from the resin, a rise in the temperature of the mold 2 caused by eddy current loss is suppressed in the orientation step and impact (magnetic force) hardly acts on the mold 2 itself instantaneously. As a result, the mold 2 is hardly wasted.

If the pulse magnetic field H is applied to the green compact 10 held in the mold, the intensity of the magnetic field acting effectively on the green compact 10 in the mold is lower than that of the pulse magnetic field H outside the mold since the saturation magnetic flux density of a metal (for example, iron) constituting the mold is limited. However, in the present embodiment, the mold 2 is formed from the resin, thus the intense pulse magnetic field H can be applied to the green compact 10 in the mold 2.

The resin may be an insulating resin. The use of the mold 2 composed of the insulating resin makes it easy to suppress eddy currents and reverse magnetic field in the orientation step, thus an instantaneous impact hardly acts on the mold 2 itself. The resistivity of the resin may be 1 Ω·m or more and 1×10 ²⁰ Ω·m or less, and preferably 1×10⁹ Ω·m or more and 1×10¹⁶ Ω·m or less. The formation of the mold 2 from such a high-resistivity resin makes it easy to suppress eddy currents and reverse magnetic field in the orientation step, thus an instantaneous impact hardly acts on the mold 2 itself. The resin used to form the mold 2 may be, for example, one or more selected from the group consisting of acrylic resins, polyethylene, polyethylene terephthalate, polypropylene, polystyrene, ABS resins (copolymer of acrylonitrile, butadiene and styrene), ethyl cellulose, paraffin waxes, styrene-butadiene copolymers, ethylene-vinyl acetate copolymers, ethylene-ethyl acrylate copolymers, atactic polypropylene, methacrylic acid copolymers, polyamide, polybutene, polyvinyl alcohol, phenolic resins and polyester resins. The mold 2 composed of an electroconductive plastic with higher resistivity than metals or graphite may be used. As a result, the electrification of the mold 2 is suppressed and the adhesion of the alloy powder to the mold 2 caused by the electrification of the mold 2 is suppressed.

As a contact area between a part of the mold 2 where the eddy current flows and the green compact 10 is wider, cracking of the sintered body and its deterioration in magnetic properties caused by the eddy current arise more easily. In the present embodiment, the contact area between the green compact 10 and the side mold 6, out of the lower mold 8, the side mold 6 and the upper mold 4, is wider than that between the green compact 10 and each of the lower mold 8 and the upper mold 4. Accordingly, out of the lower mold 8, the side mold 6 and the upper mold 4, at least the side mold 6 may be formed from the resin. When the side mold 6 with a wide area contacting the green compact 10 is from the resin, eddy currents and reverse magnetic field are effectively restrained from being generated in the side mold 6, and cracking of the rare earth magnet and its deterioration in magnetic properties caused the eddy current and the reverse magnetic field are easily suppressed.

The structure of the mold is not limited to the above-mentioned structure. Position of a part formed from the resin in the mold 2 is not limited, either. A part of the mold 2 where the suppressing of eddy currents is required may be formed from the resin, correspondingly to the dimensions and the shape of the mold 2 or the direction of the pulse magnetic field H. For example, eddy currents and the reverse magnetic field are easily generated in a part of the mold 2 where a circuit circling around a direction of the pulse magnetic field H orienting the alloy powder is formed. In other words, eddy currents and reverse magnetic field are easily generated when a penetrated part of the side mold 6 (inner walls 6a of the side mold 6) is parallel with the pulse magnetic field H. Accordingly, eddy currents and reverse magnetic field are easily suppressed when the side mold 6 of the mold 2 is formed from the resin, this side mold being a part where a circuit circling around the direction of the pulse magnetic field H orienting the alloy powder is formed.

All of the lower mold 8, the side mold 6, and the upper mold 4 may be formed from a resin. Only the side mold 6, out of the lower mold 8, the side mold 6, and the upper mold 4, may be formed from a resin. Only the lower mold 8, out of the lower mold 8, the side mold 6, and the upper mold 4, may be formed from a resin. Only the upper mold 4, out of the lower mold 8, the side mold 6, and the upper mold 4, may be formed from a resin. Out of the lower mold 8, the side mold 6, and the upper mold 4, the side mold 6 and the upper mold 4 may be formed from a resin, and the lower mold 8 may be formed from a composition other than any resin. Out of the lower mold 8, the side mold 6, and the upper mold 4, the lower mold 8 and the side mold 6 may be formed from a resin, and the upper mold 4 may be formed from a composition other than any resin. Out of the lower mold 8, the side mold 6, and the upper mold 4, the lower mold 8 and the upper mold 4 may be formed from a resin, and the side mold 6 may be formed from a composition other than any resin. When a part of the mold 2 is formed from a resin, other parts of the mold 2 may be formed from, for example, at least one selected from the group consisting of iron, silicon steel, stainless steel, permalloy, aluminum, molybdenum, tungsten, carbonaceous materials, ceramic materials, and silicone resins. The part of the mold 2 other than any resin may be formed from an alloy (for example, aluminum alloy).

If all of the lower mold 8, the side mold 6, and the upper mold 4 are made of a metal, the side mold 6 and the upper mold 4 are abraded with each other in the molding step, thus metal wastes may fall off the surface of the side mold 6 or the upper mold 4 to be incorporated into the green compact 10. The metal wastes (for example, aluminum or aluminum alloy) incorporated into the green compact 10 may damage magnetic properties of the finally obtained rare earth magnet. In contrast, a part or the whole of the mold 2 is formed from a resin in the present embodiment. Thus, effects on magnetic properties of the rare earth magnet by the abrasion wastes (resin) of the mold 2 is suppressed compared with the case where the mold 2 is composed of only a metal. For example, in a case where one (for example, the side mold 6) of the side mold 6 and the upper mold 4 is formed from a resin and the other (for example, the upper mold 4) is formed from a metal, resin wastes with lower hardness than metals are generated in place of metal wastes in the mold by the friction between the side mold 6 and the upper mold 4. The resin wastes more hardly damage magnetic properties of the rare earth magnet than the metal wastes. For example, only the side mold 6 may be formed from a resin, and the lower mold 8 and the upper mold 4 may be formed from a metal (for example, aluminum or aluminum alloy).

The shrinkage ratio of a neodymium magnet in the sintering step is anisotropic. Thus, it is difficult to predict precisely the shape (in particular, a complicated shape) of the shrunken neodymium magnet (sintered body). Therefore, it is necessary for net shape to make trials and errors to adjust the dimensions and the shape of the mold 2, thus a resin, which is easily cut and polished, is suitable as the material of the mold 2. In other words, molds 2 formed from a resin are suitable for effective production of a wide variety of rare earth magnets corresponding to various applications. Conventional metal molds are difficult to be processed and are expensive, thus metal molds are unsuitable for the production of a wide variety of rare earth magnets corresponding to various applications.

When the molding step and the orientation step are repeated using the same mold 2, the inside of the mold 2 may be cleaned up in each of times of the molding and the orienting. For example, an extra of the alloy powder remaining in the mold 2 may be pulled up by a magnetic field to cleaned up the inside of the mold 2. In each of times of the molding and orienting, the cleaning-up of the inside of the mold 2 improves the accuracy of weighing of the alloy powder to be molded in the mold 2 so as to suppress variations in the density and the dimensions of the resultant green compact 10. As a result, variations of density, dimensions and magnetic properties in the finally obtained rare earth magnets are suppressed. If the mold 2 is formed from a ferromagnetic metal (for example, iron), the mold 2 itself is pulled by the magnetic field when the inside of the mold 2 is cleaned up, thus the mold 2 is not easily cleaned. However, when the mold 2 is formed from a resin having no ferromagnetism, the mold 2 itself is not pulled by the magnetic field, thus the inside of the mold 2 is easily cleaned. If the mold 2 is formed from a ferromagnetic metal (for example, iron), the mold 2 itself is magnetized in the orientation step, thus the alloy powder adheres unfavorably to the mold 2. Thus, the orientation of the alloy powder is disturbed, or the shape retaining ability of the green compact 10 is deteriorated. However, the magnetization of the mold 2 itself is suppressed by the use of the mold 2 formed from a resin.

While the alloy powder is supplied into the mold 2, the mass of the alloy powder to be molded in the mold 2 may be measured together with the mass of the mold 2. When the mass of the alloy powder to be molded in the mold 2 and the mass of the mold 2 are measured simultaneously, the accuracy of the weighting device becomes lower as the mass of the mold 2 is heavier, thus the measurement accuracy of the mass of the alloy powder itself also becomes lower. However, it possible to measure the mass of the alloy powder as well as the mass of the mold 2 itself with a high accuracy by the use of the mold 2 composed of a resin which is lighter than conventional metals.

While the alloy powder in the mold 2 is pressurized, the alloy powder may be oriented by the pulse magnetic field H. In other words, the green compact 10 in the mold 2 may be compressed also in the orientation step. A pressure exerted on the green compact 10 by the mold 2 may be adjusted to 0.049 MPa or more and 20 MPa or less for the above-mentioned reason.

In the separation step, at least a part of the mold 2 is separated from the green compact 10. For example, in the separation step, the upper mold 4 and the side mold 6 may be separated and removed from the green compact 10, thereby placing the green compact 10 on the lower mold. The side mold 6 and upper mold 4 holding the green compact 10 may be separated from the lower mold to place the side mold 6 and upper mold 4 holding the green compact 10 on a tray for the heating step. Then, the side mold 6 and the upper mold 4 may be separated from the green compact 10 to place the green compact 10 on the tray for the heating step. One or both of the upper mold 4 and the side mold 6 may be able to be disassembled and assembled. In the separation step, one or both of the upper mold 4 and the side mold 6 may be removed from the green compact 10 by disassembling one or both of the upper mold 4 and the side mold 6.

The density of the green compact 10 (the green compact 10 before the heating step) which has undergone the molding step and the orientation step may be adjusted to 3.0 g/cm³ or more and 4.4 g/cm³ or less, preferably 3.2 g/cm³ or more and 4.2 g/cm³ or less, and more preferably 3.4 g/cm³ or more and 4.0 g/cm³ or less. For example, the density of the green compact 10 may be adjusted by the pressure exerted on the green compact 10 by the mold 2. For example, the density of the green compact 10 may be adjusted by the mass of the alloy powder supplied into the mold 2.

A heating step may be conducted subsequently to the separating step. In the heating step, the green compact 10 may be heated to adjust the temperature of the green compact 10 to 200° C. or higher to 450° C. or lower. In the heating step, the temperature of the green compact 10 may be adjusted to 200° C. or higher and 400° C. or lower, or 200° C. or higher and 350° C. or lower. In the molding step, the pressure on the alloy powder is lower than that in the conventional high-pressure magnetic field pressing method, thus making it difficult to harden the alloy powder by pressurizing, and making the obtained green compact 10 likely to collapse. However, the shape retaining ability of the green compact 10 is improved by the heating step.

In the heating step, when the temperature of the green compact 10 reaches 200° C. or higher, the green compact 10 begins to be hardened, thereby improving the shape retaining ability of the green compact 10. In other words, when the temperature of the green compact 10 reaches 200° C. or higher, the mechanical strength of the green compact 10 is improved. Since the shape retaining ability of the green compact 10 is improved, the green compact 10 is unlikely to be broken in transfer of the green compact 10 or handling of the green compact 10 in a subsequent step. For example, the green compact 10 is unlikely to collapse when the green compact 10 is gripped with a carrying chuck or the like, and disposed on a tray for sintering. As a result, defects of the finally obtained rare earth magnet are suppressed.

If the temperature of the green compact 10 exceeds 450° C. in the heating step, cracks in the green compact 10 is likely to be formed in the sintering step conducted after the heating step. The cause of the crack formation is not certain. For example, hydrogen remaining in the green compact 10 may blow off as a gas to the outside of the green compact 10 by a rapid increase in green compact 10 temperature in the heating step, thereby cracks in the green compact 10 could be formed. However, cracks in the green compact 10 are suppressed in the sintering step by adjusting the temperature of the green compact 10 to 450° C. or lower in the heating step. As a result, cracks in the finally obtained rare earth magnet are also easily suppressed. In addition, the temperature of the green compact 10 is adjusted to 450° C. or lower in the heating step, thus shortening the time required for increasing the green compact 10 temperature or cooling the green compact 10, and improving the productivity of the rare earth magnet. In addition, the temperature of the green compact 10 in the heating step is 450° C. or lower, which is lower than the general sintering temperature, thus deterioration of mold 2 or a chemical reaction between the green compact 10 and the mold 2 is unlikely to be caused, even if the green compact 10 is heated together with a part of the mold 2 (for example, the lower mold 8). Accordingly, even a mold 2 composed of a composition (resin) which is not necessarily high in heat resistance can be used.

The mechanism that the shape retaining ability of the green compact 10 is improved by adjusting the temperature of the green compact 10 to 200° C. or higher and 450° C. or lower is not clear. For example, there is a possibility that an organic substance (for example, a lubricant) added to the alloy powders will turn into carbon in the heating step, thereby binding the alloy powders (alloy particles) to each other with the carbon interposed therebetween. As a result, the shape retaining ability of the green compact 10 may be improved. If the temperature of the green compact 10 exceeds 450° C. in the heating step, there is a possibility that a carbide of the metal constituting the alloy powder will be formed, or the alloy powders (alloy particles) may be sintered directly to each other. On the other hand, in a case in which the temperature of the green compact 10 is adjusted to 200° C. or higher and 450° C. or lower, a carbide of the metal is not necessarily produced, and the alloy particles are not necessarily sintered directly to each other.

The time for keeping the temperature of the green compact 10 at 200° C. or higher and 450° C. or lower in the heating step is not particularly limited, and may be appropriately adjusted in accordance with the size and shape of the green compact 10.

In the heating step, the green compact 10 may be heated by irradiating the green compact 10 with infrared rays. Directly heating the green compact 10 by infrared irradiation (that is, radiant heat) shortens the time required for increasing the temperature of the green compact 10 as compared with a case of heating by conduction or convection, thereby improving the production efficiency and the energy efficiency. However, in the heating step, the green compact 10 may be heated by heat conduction or convection inside a heating furnace. The wavelength of the infrared ray may be, for example, 0.75 μm or more and 1000 μm or less, preferably 0.75 μm or more and 30 pin or less. The infrared ray may be at least one selected from the group consisting of near infrared rays, short wavelength infrared rays, medium wavelength infrared rays, long wavelength infrared rays (thermal infrared rays), and far infrared rays. Among the infrared rays mentioned above, the near infrared rays are relatively easily absorbed by metals. Accordingly, in the case of irradiating the green compact 10 with near infrared rays, the temperature of the metal (alloy powder) is easily increased in a short period of time. On the other hand, among the infrared rays mentioned above, the far infrared rays are easily absorbed by organic substances, and easily reflected by metals (alloy powder). Accordingly, in the case of irradiating the green compact 10 with far infrared rays, the above-described organic substance (for example, a lubricant) is easily selectively heated, and the green compact 10 is easily hardened by the above-mentioned mechanism associated with the organic substance. In the case of irradiating the green compact 10 with infrared rays, for example, an infrared heater (ceramic heater or the like) or an infrared lamp may be used.

When the green compact 10 separated from a part or the whole of the mold 2 is heated in the heating step, deterioration of the mold 2 by the heating (for example, deformation, hardening, or abrasion of the mold) is suppressed, and seizure between the green compact 10 and the mold 2 is easily suppressed. Furthermore, when the green compact 10 separated from a part or the whole of the mold 2 is heated, the mold 2 is hard to insulate heat, thus the green compact 10 is easily heated. As a result, the shape retaining ability of the green compact 10 is improved. When the green compact 10 separated from a part or the whole of the mold 2 is heated, the mold 2 is less likely to react with the green compact 10 chemically. For this reason, heat resistance is not necessarily required for the mold 2. Thus, the material of the mold 2 is hardly restricted. Accordingly, as a raw material for the mold 2, it is easy to select a material which is easily processed into desired size and shape and inexpensive. If the green compact 10 and the whole of the mold 2 are heated all at once in the heating step, stress is likely to act on the green compact 10 due to a difference in thermal expansion coefficient between the green compact 10 and the mold 2, thereby deforming or breaking the green compact 10. In addition, if the green compact 10 and the whole of the mold 2 are heated all at once in the heating step, the entire heating objective is large in volume and heat capacity. As a result, the number of green compact 10s to be heated all at once is limited, thereby increasing the time required for the heating step, resulting in energy waste, and decreasing the productivity of the rare earth magnet.

In the heating step, for example, the green compact 10 placed on the lower mold 8 may be heated. In the heating step, the green compact 10 placed on a tray for the heating step may be heated. In the heating step, the green compact may be heated in an inert gas or in a vacuum in order to suppressing oxidization of the green compact 10. The inert gas may be a rare gas such as argon.

In the heating step, the green compact 10 may be cooled to 100° C. or lower after adjusting the temperature of the green compact 10 to 200° C. or higher and 450° C. or lower. When the surface of chuck used for transfer of the green compact 10 after the heating step is made of a resin, the cooling of the green compact 10 suppresses a chemical reaction between the surface of the chuck and the green compact 10, thereby suppressing deterioration of the chuck and contamination of the surface of the green compact 10. The cooling method may be natural cooling, for example.

After the orientation step, a sintering step is conducted. After the orientation step, the sintering step may be conducted without conducting the heating step. After the orientation step, the sintering step may be conducted, following the heating step. In the sintering step, the green compact 10 separated from the whole of the mold 2 is heated to be sintered. In other words, in the sintering step, the alloy particles in the green compact 10 are sintered to each other to obtain a sintered body (rare earth magnet).

The density of the green compact 10 to be sintered in the sintering step (the density of the green compact 10 just before the sintering step) is adjusted to 3.0 g/cm³ or more and 4.4 g/cm³ or less. The density of the green compact 10 to be sintered in the sintering step (the density of the green compact 10 just before the sintering step) may be adjusted preferably to 3.2 g/cm³ or more and 4.2 g/cm³ or less, and more preferably 3.4 g/cm³ or more and 4.0 g/cm³ or less. As the pressure exerted on the green compact 10 (alloy powder) by the mold is lower in the molding step and the orientation step, the density of the green compact 10 tends to be lower just before the sintering step. In addition, as the pressure exerted on the green compact 10 (alloy powder) by the mold is lower in the molding step and the orientation step, the alloy powder constituting the green compact 10 is more likely to freely rotate, and more likely to be oriented along the magnetic field. As a result, the residual magnetic flux density Br of the rare earth magnet finally obtained is more likely to be increased. Thus, it can be said that the residual magnetic flux density of the rare earth magnet is more likely to be increase as the density of the green compact 10 just before the sintering step is lower. However, if the pressure exerted on the green compact 10 (alloy powder) by the mold is excessively low in the molding step and the orientation step, the shape retaining ability (mechanical strength) of the green compact 10 is insufficient, and the orientation of the alloy powder located at the surface of the green compact 10 is disturbed by the friction between the green compact 10 and the mold associated with the separation step. As a result, the residual magnetic flux density of the finally obtained rare earth magnet is decreased. Accordingly, if the density of the green compact 10 just before the sintering step is excessively low, it can be said that the residual magnetic flux density of the rare earth magnet is low. On the other hand, as the pressure exerted on the green compact 10 (alloy powder) is higher during the period from the molding step to the sintering step, the density of the green compact 10 just before the sintering step is higher, and the shape retaining ability (mechanical strength) of the green compact 10 is higher. As a result, cracks in the finally obtained rare earth magnet are more likely suppressed. Accordingly, it can be said that cracks in the rare earth magnet are more likely to be suppressed as the density of the green compact 10 just before the sintering step is higher. However, if the pressure exerted on the green compact 10 (alloy powder) by the mold is excessively high in the molding step and the orientation step, cracks in the green compact 10 is likely to be formed due to springback, and cracks remain in the rare earth magnet obtained from the green compact 10. It is to be noted that the springback is a phenomenon in which the green compact 10 expands when the pressure is released after molding the alloy powder under pressure. As described above, the density of the green compact 10 just before the sintering step correlates with the residual magnetic flux density and the crack in the rare earth magnet. The density of the green compact 10 just before the sintering step is adjusted to fall within the ranges mentioned above, thereby easily increasing the residual magnetic flux density Br of the rare earth magnet, and cracks in the rare earth magnet is easily suppressed.

The density of the green compact 10 just before the sintering step may be adjusted by the mass of the alloy powder introduced into the mold 2 in the molding step, and by the pressure exerted on the green compact 10 (alloy powder) by the mold 2 in the molding step. The density of the green compact 10 just before the sintering step may be adjusted into the above-mentioned numerical ranges by compressing the green compact 10 (alloy powder) plural times during the time from the molding step to the sintering step. In short, the green compact 10 may be further pressurized in a step different from the molding step. In order to suppress cracks in the rare earth magnet, it is better to adjust the pressure exerted on the metal powder to 0.049 MPa or more and 20 MPa or less during the time from the molding step to the sintering step.

If the green compact 10 and the mold 2 are heated together in the sintering step without separating the green compact 10 from the mold 2, the resin constituting the mold 2 is discomposed and a carbon component derived from the resin may be unfavorably incorporated into the green compact 10. Even if the mold made of the resin is burned out in the process of the sintering step, it is difficult to restrain sufficiently the carbon component generated by the burning-out from being incorporated into the green compact 10. As a result, the carbon component remains the sintered body (rare earth magnet) and the carbon component impairs magnetic properties (for example, the coercivity) of the rare earth magnet. In contrast, in the sintering step in the present embodiment, the green compact 10 separated from the mold 2 is heated, thus a carbon component derived from the resin is hardly incorporated into the green compact 10. Thus, magnetic properties (for example, the coercivity) of the resultant rare earth magnet are hardly impaired by the carbon component.

If the green compact 10 and a part or the whole of the mold 2 are heated all at once in the sintering step, stress acts easily on the green compact 10 by a difference in thermal expansion coefficient between the green compact 10 and the mold 2, thus the green compact 10 may be deformed or broken. Furthermore, when the green compact 10 and the whole of the mold 2 are heated all at once in the sintering step, the whole of the heating objective is large in volume and heat capacity. As a result, the number of green compacts 10 to be heated all at once is limited, thereby increasing the time required for the sintering step, resulting in energy waste, and decreasing the productivity of the rare earth magnet. In contrast, in the present embodiment, the green compact 10 separated from the mold 2 is heated in the sintering step; thus, the whole of the heating objective is smaller in the volume and heat capacity to be heated compared with the case of heating the green compact 10 and the whole of the mold 2 all at once. As a result, respective temperatures of many green compacts 10 are easily raised collectively, thereby suppressing easily time and energy required for the sintering step to improve productivity of the rare earth magnets.

In the sintering step, the green compact 10 placed on the lower mold 8 may be transferred onto a tray for sintering. In the sintering step, the green compact 10 placed for the heating step may be transferred onto a tray for sintering. Since the shape retaining ability of the green compact 10 is improved in the heating step, breakage of the green compact 10 is suppressed when the green compact 10 is gripped with a carrying chuck, and arranged on the tray for sintering.

In the sintering step, a plurality of green compacts 10 may be placed on a tray for sintering, and the plurality of green compacts 10 placed on the tray for sintering may be heated all at once. The productivity of the rare earth magnet is improved by arranging a large number of green compacts 10 on the tray for sintering at a narrow interval, and heating the large number of green compacts 10 all at once.

The composition of the tray for sintering may be any composition as long as the composition is unlikely to react with the green compact 10 during the sintering and unlikely to produce a substance which contaminates the green compact 10. For example, the tray for sintering may be made of molybdenum or a molybdenum alloy.

The sintering temperature may be, for example, 900° C. or higher and 1200° C. or lower. The sintering time may be, for example, 0.1 hour or longer and 100 hours or shorter. The sintering step may be repeated. In the sintering step, the green compact 10 may be heated in an inert gas or a vacuum. The inert gas may be a rare gas such as argon.

The sintered body may be subjected to an aging treatment. In the aging treatment, the sintered body may be subjected to a heat treatment at, for example, 450° C. or higher and 950° C. or lower. In the aging treatment, the sintered body may be subjected to a heat treatment for, for example, 0.1 hour or longer and 100 hours or shorter. The aging treatment may be carried out in an inert gas or a vacuum. The aging treatment may be composed of multi-step heat treatments at different temperatures.

The sintered body may be cut or polished. A protective layer may be formed on the surface of the sintered body. The protective layer may be, for example, a resin layer or an inorganic layer (for example, a metal layer or an oxide layer). The method for forming the protective layer may be, for example, a plating method, a coating method, a vapor deposition polymerization method, a gas-phase method, or a chemical conversion treatment method.

The dimensions and shape of the rare earth magnet varies depending on the intended use of the rare earth magnet, and are not particularly limited. The shape of the rare earth magnet may be, for example, a rectangular parallelepiped shape, a cubic shape, a polygonal prism shape, a segment shape, a fan shape, a rectangular shape, a plate shape, a spherical shape, a disk shape, a cylindrical shape, a ring shape, or a capsule shape. The cross section of the rare earth magnet may have, for example, a polygonal shape, a circular chord shape, an arcuate shape, or a circular shape. The dimensions and shape of the mold 2 or cavity corresponds to the dimensions and shape of the rare earth magnet, which are not limited. [Examples]

Hereinafter, the present invention will be described in more detail with reference to examples, but the present invention is not to be limited to these examples.

### Example 1

An orientation step of Example 1 was simulated by a simulation using a computer as described below. The simulation was based on a finite element method. A software “COMSOL Multiphysics” manufactured by COMSOL Co., Ltd. was used for the simulation.

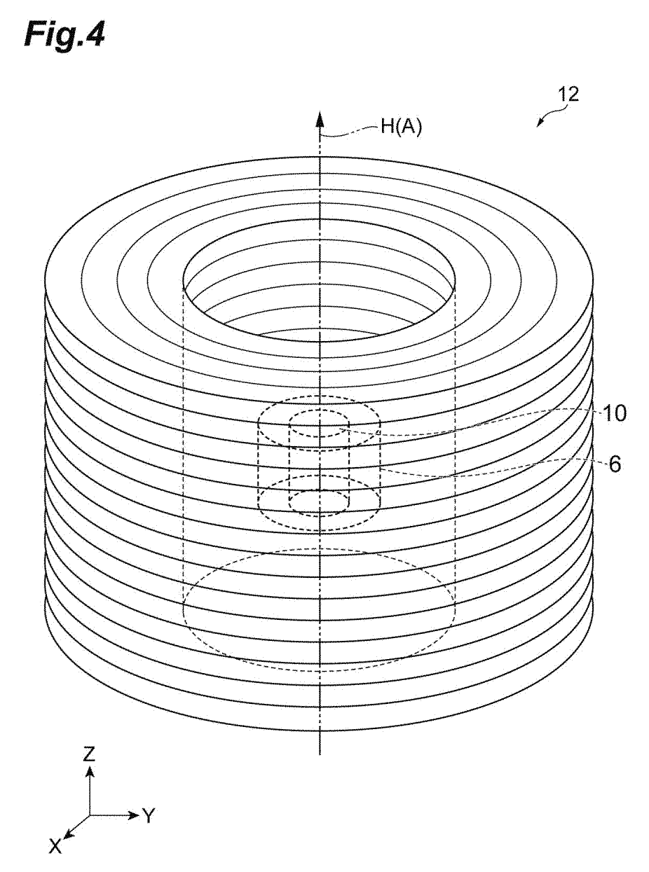

As shown in FIG. 4, a columnar side mold 6 consisting of an acrylic resin was used in the orientation step of Example 1. The side mold 6, and a columnar green compact 10 filled into the side mold 6 were arranged inside an air-core coil 12. A pulse magnetic field H generated by the air-core coil 12 was applied to the side mold 6 and the green compact 10. A surface of the side mold 6 that contacted the green compact 10 (i.e., an inner wall of the side mold 6) was parallel with the pulse magnetic field H. The side mold 6 and the green compact 10 were located at the center of the air-core coil 12 in the direction of the pulse magnetic field H. The inner diameter φ of the side mold 6 (the diameter of the green compact) was 20 mm. The outer diameter φ′ of the side mold 6 was 36 mm. The length of the side mold 6 was 26 mm. In the simulation described below, a time when a current started to flow in the air-core coil 12 was regarded as zero.

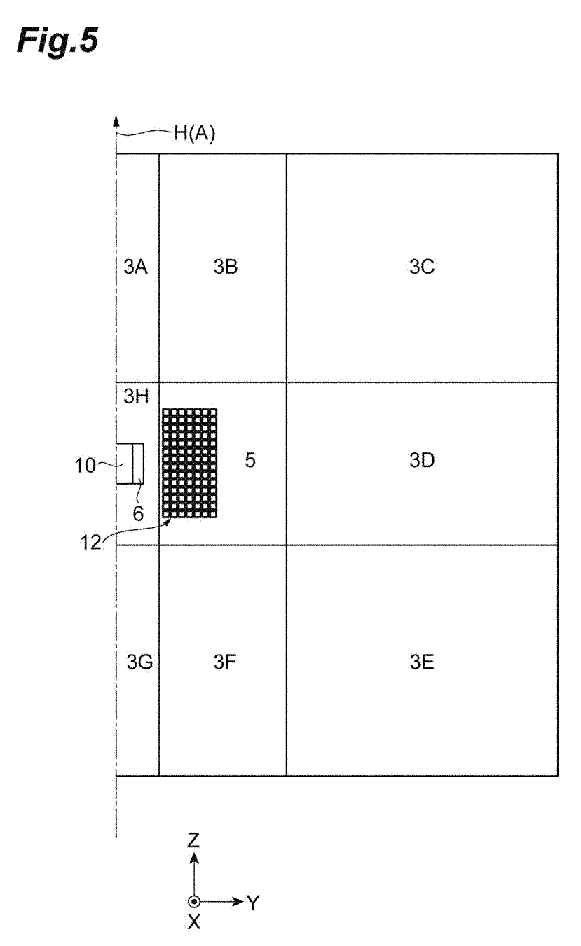

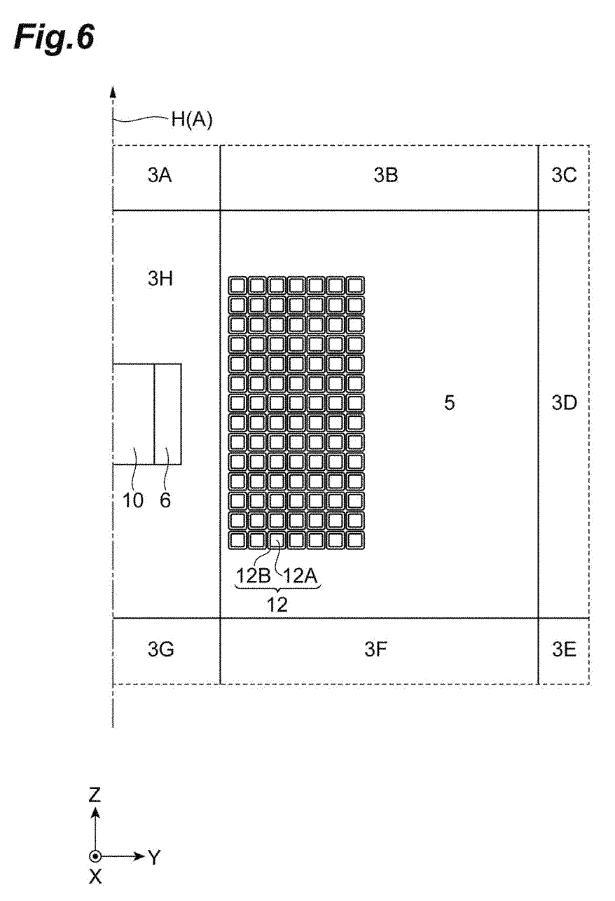

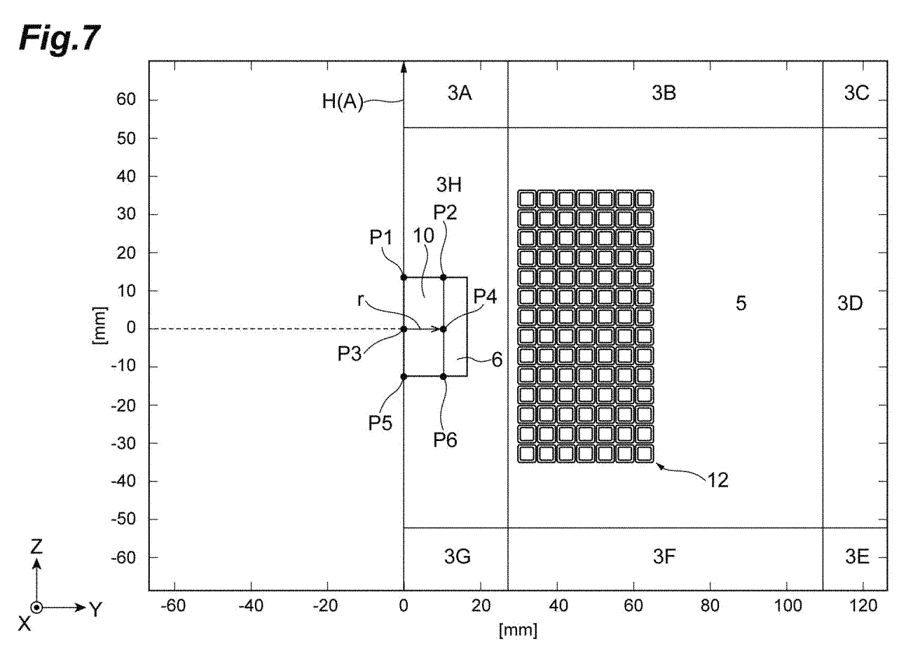

As shown in FIG. 4, the side mold 6, the green compact 10 and the air-core coil 12 each had a rotational symmetry around an axis A. Accordingly, the orientation step was simulated on the basis of a two-dimensionally axial symmetry model shown in each of FIG. 5, FIG. 6 and FIG. 7. The direction of the pulse magnetic field H was parallel with a central axis (axis A) of each of the side mold 6, the green compact 10 and the air-core coil 12. All of FIG. 5, FIG. 6 and FIG. 7 show the same axial symmetry model. Any numeral value on each of a vertical axis and a transverse axis of FIG. 7 represents a position in the axial symmetry model. The unit of the numerical number on each of the vertical axis and the transverse axis of FIG. 7 is millimeter(s).

As shown in FIG. 5, FIG. 6 and FIG. 7, an atmosphere around the green compact 10, the side mold 6 and the air-core coil 12 was divided into eight regions 3A, 3B, 3C, 3D, 3E, 3F, 3G, and 3H). The composition of each of regions constituting the two-dimensional model was as follows:

3A, 3B, 3C, 3D, 3E, 3F, 3G, and 3H: Argon,

5: Bakelite,

6: Acrylic resin,

10: Nd₂Fe₁₄B,

12A: Water (cooling water), and

12B: Copper (copper line constituting the air-core coil).

As input values for the simulation, the following physical property values were used:

Relative magnetic permeability of Nd₂Fe₁₄B: 1.05,

Electric conductivity of argon: 1.0×10⁻¹⁴ S/m,

Relative dielectric constant of argon: 1.0005,

Relative magnetic permeability of argon: 1,

Electric conductivity of copper: 5.8×10⁷ S/m,

Relative dielectric constant of copper: 0.000001,

Relative magnetic permeability of copper: 0.9999,

Electric conductivity of acrylic resin: 1.0×10⁻¹⁴ S/m,

Relative dielectric constant of acrylic resin: 3.4,

Relative magnetic permeability of acrylic resin: 1,

Electric conductivity of water 5.5×10⁻⁶ S/m,

Relative dielectric constant of water: 80,

Relative magnetic permeability of water: 0.9999,

Electric conductivity of bakelite: 1.0×10⁻⁹ S/m,

Relative dielectric constant of bakelite: 4.8, and

Relative magnetic permeability of bakelite: 1.

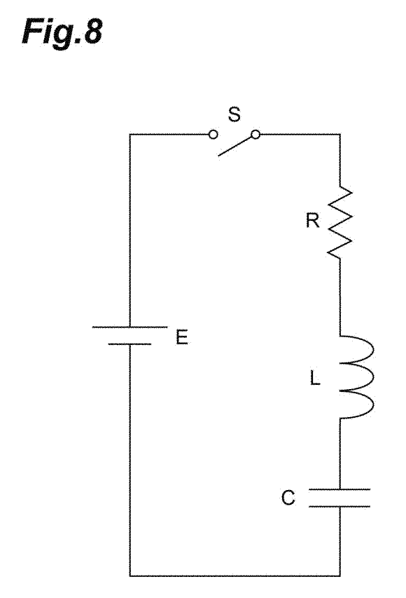

A magnetic field generating apparatus having the air-core coil 12 is represented by a circuit diagram shown in FIG. 8. The simulation was conducted under conditions satisfying a mathematical formula 1 described below. When the mathematical formula 1 is satisfied, a current flowing in the air-core coil 12 has an alternate current attenuated waveform represented by a formula 2 described below. In short, the pulse magnetic field H is an attenuated alternate magnetic field.

$$\begin{matrix}[ Mathematical formula 1 ] & \\ \frac{1}{LC} - {( \frac{R}{2 L} )}^{2} > 0 & ( 1 ) \\ [ Mathematical formula 2 ] & \\ i = \frac{E}{\sqrt{\frac{1}{LC} - {( \frac{R}{2 L} )}^{2}}} {e}^{- \frac{R}{2 L} t} \cdot sin \sqrt{\frac{1}{LC} - {( \frac{R}{2 L} )}^{2}} t & ( 2 )\end{matrix}$$

The meanings of respective characters shown in FIG. 8, the formula 1 and the formula 2 are as follows. S in FIG. 8 represents a switch.

E: Voltage (unit: V),

C: Electrostatic capacity (unit: F),

L: Inductance (unit: H),

R: Resistance (Ω), and

t: Time (unit: second(s)).

In the simulation, respective input values for E, C, L and R were as follows.

E: 2530 V,

C: 3600 μF,

L: 550 μH, and

R: 50 mΩ.

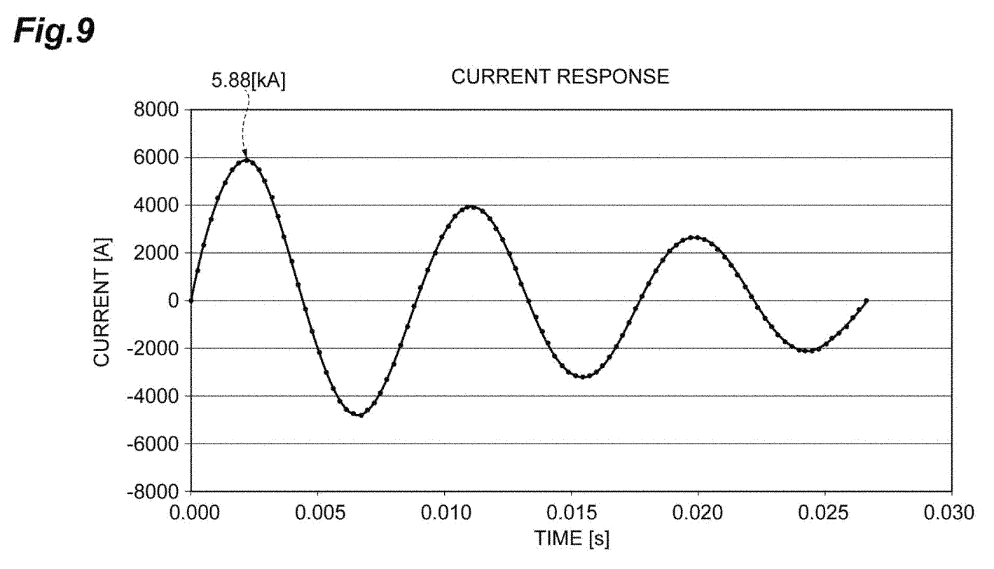

The current flowing in the air-core coil 12, which was obtained from each of the above-mentioned input values and the expression 2, is shown in FIG. 9. The angular frequency ω of the first wave P1 of a sinewave shown in FIG. 9 was 6486 rad/second. The angular frequency ω of the second wave P2 of the sinewave shown in FIG. 9 was −45.5 rad/second. The angular frequency co of the third wave P3 of the sinewave shown in FIG. 9 was 709.2 rad/second. The frequency f of the sinewave shown in FIG. 9 was 112.9 Hz. The cycle of the sinewave shown in FIG. 9 was 8.9×10−3 seconds.

The magnetic force Fₘ acting on the individual alloy particles (magnetic particles consisting of Nd₂Fe₁₄B) contained in the green compact 10 in the orientation step is represented by a formula 3 described below.

[Mathematical formula 3]

Fₘ=½Gμ₀(μₐ−1)gradh² (3)

The meanings of respective characters in the formula 3 are as follows.

G: Volume of the alloy particles,

μ₀: Magnetic permeability of vacuum,

μₐ: Effective magnetic permeability (apparent relative magnetic permeability), and

h: Magnetic field acting on the alloy particles.

The effective magnetic permeability p, is usually calculated in accordance with the following formula 4:

$$\begin{matrix}[ Mathematical formula 4 ] & \\ {μ}_{a} = \frac{{μ}_{r}}{N {μ}_{r} + 1} & ( 4 )\end{matrix}$$

N in the formula 4 is the demagnetizing factor of the alloy particles. μᵣ is the relative magnetic permeability of the magnetic core material. The demagnetizing factor N was unclear, thus N=0 (that is, μₐ=μᵣ) was presupposed in the simulation,

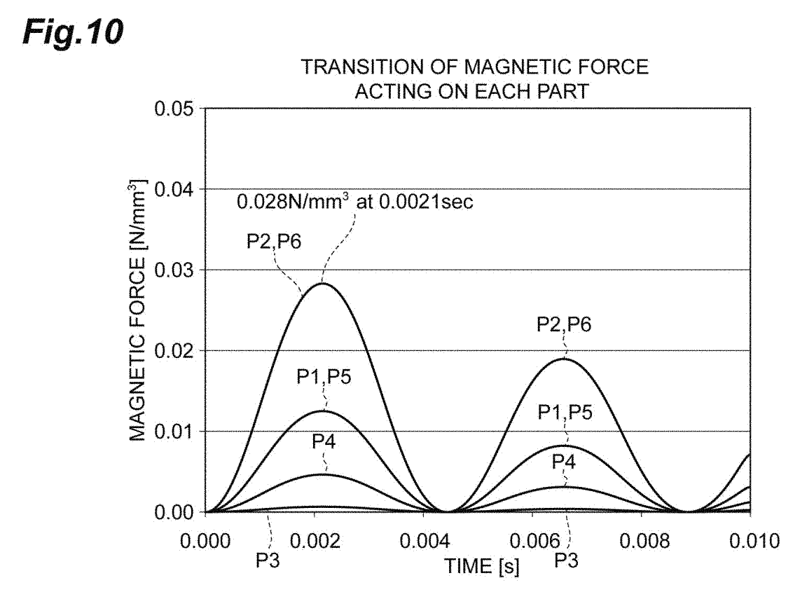

The transition of a magnetic force acting on alloy particles positioned at each of point P1, point P2, point P3, point P4, point P5 and point P6 shown in FIG. 7 is shown in FIG. 10. The value shown by a vertical axis of FIG. 10 is the magnetic force (unit: N/mm³) of the alloy particles per unit volume.

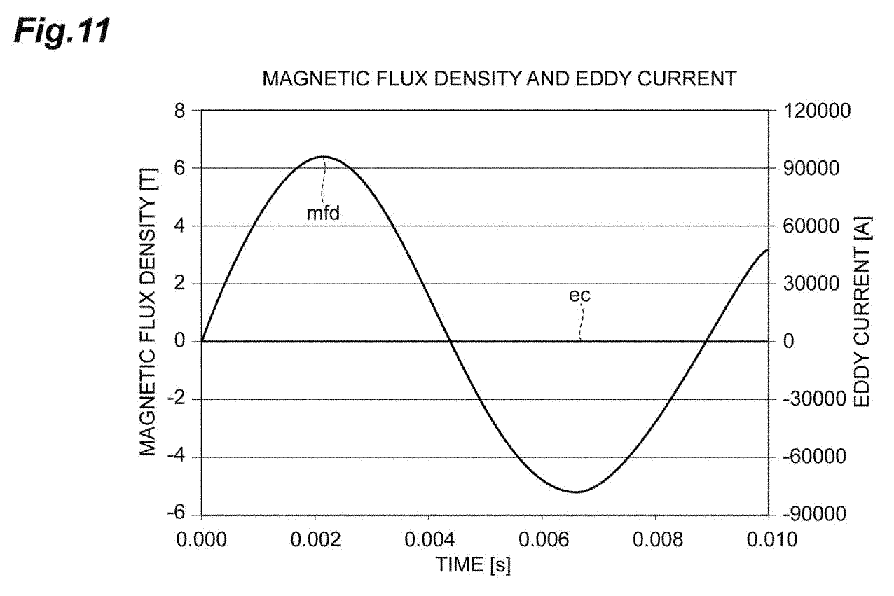

The transition of the magnetic flux density mfd at the point P3 shown in FIG. 7 is shown in FIG. 11. The point P3 is positioned on a central axis (axis A) of the green compact 10, and further positioned at the center of a cross section (circle) dividing the green compact 10 into two equal parts in the direction of the central axis. The direction of the magnetic flux density mfd at the point P3 is the same as that of the pulse magnetic field H (axis A) shown in each of FIG. 4, FIG. 5, FIG. 6 and FIG. 7.

The transition of an eddy current ec flowing in the side mold 6 in the orientation step is shown in FIG. 11. As shown in FIG. 11, no eddy current ec flowed in the side mold 6 in the orientation step of Example 1.

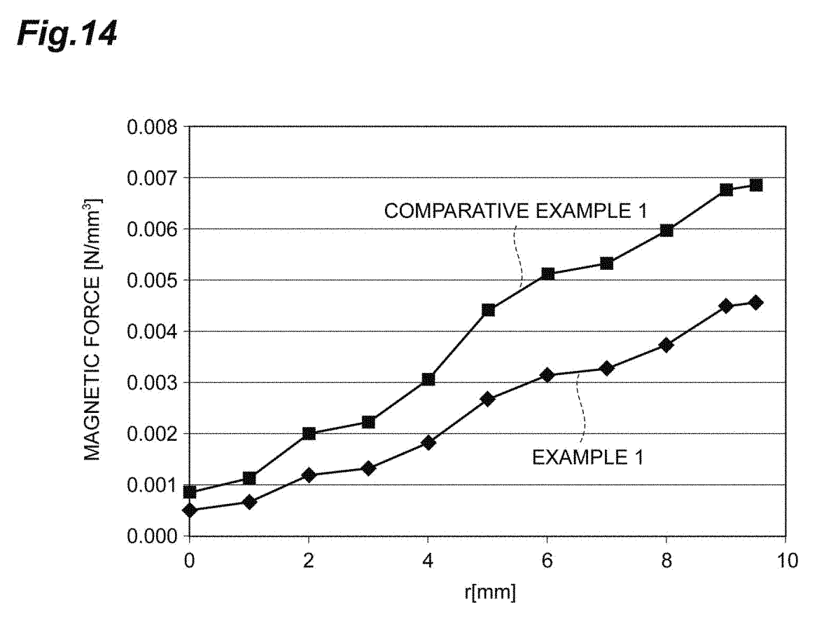

A coordinate axis r shown in FIG. 7 is perpendicular to the central axis (axis A) of the green compact 10, and is extended from the point P3 (starting point zero) shown in FIG. 7. A magnetic force f1 acting on each of the alloy particles positioned on the coordinate axis r at a time of 2.1 milliseconds is shown in Table 1 described below and FIG. 14. As shown in FIG. 10, the time of 2.1 milliseconds is a time when the magnetic force acting on the alloy particles positioned at each of the points P2 and P6 on the coordinate axis r is maximum. The symbol r shown in Table 1 described below and FIG. 14 is the distance from the point P3 (staring point zero) to each of the alloy particles.

The direction of the magnetic force f1 acting on each of the alloy particles positioned on the coordinate axis r was parallel with the coordinate axis r, and was directed from the point P3 to the side mold 6. In other words, the magnetic force f1 pulling each of the alloy particles to the side mold 6 was generated on the coordinate axis r.

### Comparative Example 1

In a simulation of Comparative Example 1, a side mold 6 consisting of an aluminum alloy (A5052) was used instead of the side mold 6 consisting of the acrylic resin. The electric conductivity of the aluminum alloy was 2.0×10⁷ S/m. The relative dielectric constant of the aluminum alloy was 1. The relative magnetic permeability of the aluminum alloy was 1.

The simulation of Comparative Example 1 was conducted in the same way as in Example 1 except the composition of the side mold 6.

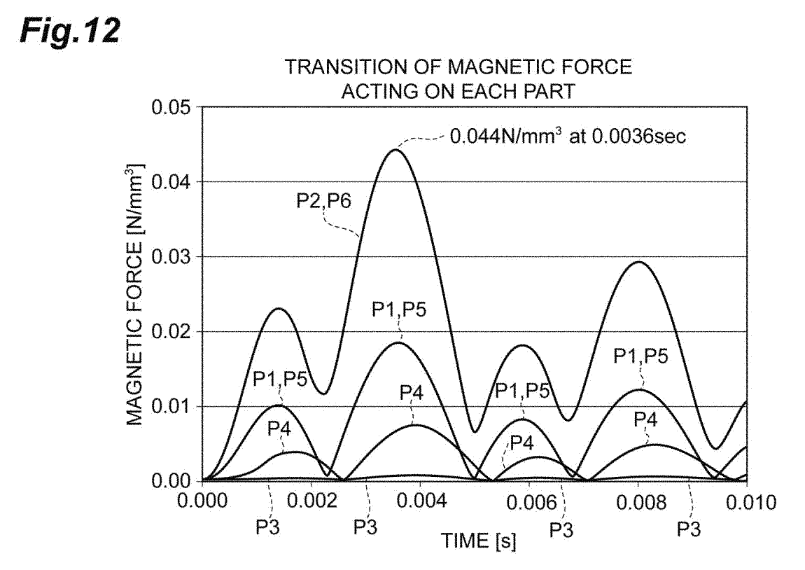

In the case of the simulation of Comparative Example 1, the transition of a magnetic force acting on the alloy particles positioned at each of the points P1, P2, P3, P4, P5 and P6 shown in FIG. 7 is shown in FIG. 12.

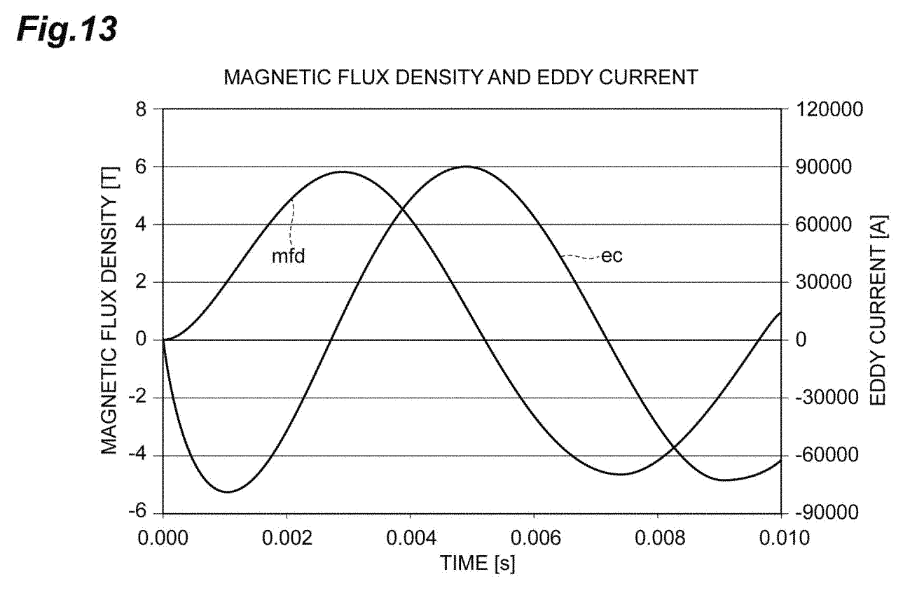

In the case of the simulation of Comparative Example 1, the transition of the magnetic flux density mfd at the point P3 is shown in FIG. 13. The direction of the magnetic flux density mfd at the point P3 is the same as that of the pulse magnetic field H (axis A) shown in each of FIG. 4, FIG. 5, FIG. 6 and FIG. 7.

In the case of the simulation of Comparative Example 1, the transition of an eddy current ec flowing in the side mold 6 in the orientation step is shown in FIG. 13. As shown in FIG. 13, the eddy current ec flowed in the side mold 6 in the orientation step of Comparative Example 1.

In the case of the simulation of Comparative Example 1, a magnetic force f2 acting on each of the alloy particles positioned on the coordinate axis r at a time of 3.6 milliseconds is shown in Table 1 described below and FIG. 14. As shown in FIG. 12, in the case of the simulation of Comparative Example 1, the time of 3.6 milliseconds is a time when the magnetic force acting on the alloy particles positioned at each of the points P2 and P6 on the coordinate axis r is maximum. Also in the case of the simulation of Comparative Example 1, the direction of the magnetic force f2 acting on each of the alloy particles positioned on the coordinate axis r was parallel with the coordinate axis r, and was directed from the point P3 to the side mold 6. In other words, the magnetic force f2 pulling each of the alloy particles to the side mold 6 was generated on the coordinate axis r.

### Comparison of Example 1 with Comparative Example 1

FIG. 11 and FIG. 13 show that the generation of an eddy current is suppressed in the side mold 6 by forming the side mold 6 from the acrylic resin. Table 1 described below and FIG. 14 show that the magnetic force (magnetic force caused by an eddy current) pulling the alloy particles constituting the green compact 10 to inner walls of the side mold 6 is suppressed by forming the side mold 6 from the acrylic resin.

TABLE 1

| | Example 1 | Comparative Example 1 | |
|---|---|---|---|
| r [mm] | f1 [N/mm³] | f2 [N/mm³] | f2/f1 [—] |
| 0 | 5.06E−04 | 8.56E−04 | 1.69 |
| 1 | 6.67E−04 | 1.13E−03 | 1.69 |
| 2 | 1.19E−03 | 2.00E−03 | 1.68 |
| 3 | 1.32E−03 | 2.23E−03 | 1.69 |
| 4 | 1.82E−03 | 3.05E−03 | 1.68 |
| 5 | 2.67E−03 | 4.40E−03 | 1.65 |
| 6 | 3.14E−03 | 5.11E−03 | 1.63 |
| 7 | 3.27E−03 | 5.32E−03 | 1.63 |
| 8 | 3.73E−03 | 5.96E−03 | 1.60 |
| 9 | 4.49E−03 | 6.76E−03 | 1.51 |
| 9.5 | 4.55E−03 | 6.85E−03 | 1.51 |

### Example 2

A flaky alloy which composition expressed by weight fraction is Nd₂₉Dy₁Fe_{bal.}B₁ was produced by a strip casting method. The alloy was coarsely pulverized by a hydrogen-occluding method to obtain a coarse powder. Oleic amide (lubricant) was added to the coarse powder. Subsequently, the coarse powder was pulverized in an inert gas by jet mill to obtain a fine powder (metal powder containing the rare earth elements). The particle diameter D50 of the fine powder was adjusted to 4 μm. The content of oxygen in the fine powder was 5000 ppm by mass or less. The content of nitrogen in the fine powder was 500 ppm by mass or less. The content of carbon the fine powder was 1000 ppm by mass or less.

In a molding step, the fine powder, to which oleic amide was added, was supplied into a mold to form a green compact. Details of the molding step were as follows:

The mold had a rectangular lower mold, a rectangular parallelepiped side mold to be disposed on the lower mold, and an upper mold to be disposed on the side mold. The upper mold and the lower mold were formed from aluminum. The side mold was formed from an acrylic resin. A rectangular parallelepiped space penetrated a central part of the side mold vertically. In short, the side mold was cylindrical. The upper mold had a shape fitting into the side mold. In the molding step, the side mold was placed on the lower mold to close a lower-surface-side opening of the side mold by the lower mold. The dimensions of a space (cavity) surrounded by the side mold and the lower mold were 20 mm×26 mm×6 mm. Subsequently, a predetermined mass of the fine powder was filled into the side mold through an upper-surface-side opening of the side mold. The whole of the side mold and the lower mold holding the fine powder was vibrated to level the fine powder in the cavity. Subsequently, the fine powder in the cavity was made denser by tapping. After the tapping, the upper mold was inserted into the side mold to compress the fine powder in the side mold by the end surface of the upper mold. The length of a part of the upper mold inserted in the side mold was 14 mm. In the molding step, the pressure exerted on the fine powder (green compact) in the mold by the upper mold was adjusted into a value shown in Table 2 described below. Hereinafter, the pressure exerted on the fine powder (green compact) in the mold by the upper mold in the molding step may be referred to as the “molding pressure”.

According to the above-mentioned procedure, 50 green compacts were produced. The dimensions of each of the resultant green compacts were 20 mm×12 mm×6 mm. The density of the green compact just after the molding step was calculated from the volume and the mass of the green compact. The density of the green compact of Example 2 just after the molding step had been adjusted into a value shown in Table 2 described below. In Table 2 described below, the density of the green compact just after the molding step was represented by “Density 1”.

In an orientation step following the molding step, a magnetic field generating apparatus having an alternate current power source was used. The magnetic field generating apparatus had an air-core coil and a capacitor. Each of the inductance L of the air-core coil and the electrostatic capacity C of the capacitor were variable and it was possible to generate a pulse magnetic field having a desired alternate current attenuated waveform by the magnetic field generating apparatus.

In the orientation step, the green compact held in the mold was located in the air-core coil, and fixed with a tool. The pulse magnetic field attenuating while reversing with the passage of time was applied to the green compact in the mold. The individual fine powder particles constituting the green compact was oriented and degaussed by the application of the pulse magnetic field (attenuating alternate magnetic field). In the orientation step, the intensity of the first wave (maximum magnetic field) of the pulse magnetic field was adjusted to 6.1 T, and the cycle of the first wave was adjusted to 9 milliseconds.

After the orientation step, the upper mold and the side mold were separated from the green compact. The green compact placed on the lower mold was heated together with the lower mold in a heating furnace. The temperature (highest temperature) of the green compact during the heating was kept at 300° C.

The green compact after the heating was separated from the lower mold and the 50 green compacts were placed on a tray for sintering. The tray for sintering was composed of molybdenum. The density of each of the green compacts in Example 2 just before the sintering step was substantially the same as that (density 1) of the green compact just after the molding step. In other words, the density of the green compact to be sintered in the sintering step was adjusted into a range of 3.0 g/cm³ or more and 4.4 g/cm³ or less.

In the sintering step, the green compact on the sintering tray was sintered in a vacuum atmosphere. The sintering temperature (highest temperature) was adjusted to 1100° C. The sintering time was adjusted to 4 hours. Subsequently to the sintering step, an aging treatment was conducted. In the aging treatment, the sintered body was heated at 900° C. (highest temperature) for one hour. Subsequently, the sintered body was heated at 500° C. (highest temperature) for one hour.

After the aging treatment, the sintered body was processed to adjust the dimensions of the sintered body to 15.5 mm×10.0 mm×3.9 mm.

Through the above-mentioned steps, 50 rare earth magnets were produced. The relative density of each of the 50 rare earth magnets was 99.5% or more.

Magnetic properties of each of the 50 rare earth magnets were measured by using a direct current BH tracer. The residual magnetic flux density Br of the rare earth magnet of Example 2 was a value shown in Table 2 described below. The residual magnetic flux density Br shown in Table 2 was an average value of the residual magnetic flux densities Br of the 50 rare earth magnets. The coercivity HcJ of the rare earth magnet in Example 2 was a value shown in Table 2 described below. The coercivity HcJ shown in Table 2 was an average value of the coercivity of the 50 rare earth magnets.

It was examined whether cracks are generated in each of the rare earth magnets by observing the 50 rare earth magnets (sintered bodies) visually. The crack generation rate in Example 2 is shown in Table 2 described below. The crack generation rate is the percentage of the number n of cracked rare earth magnets out of the 50 rare earth magnets of Example 2 (i.e., (n/50)×100=2n).

### Examples 3 to 9, and Comparative Examples 2 and 3

In the case of Examples 3 to 9, and Comparative Examples 2 and 3, the molding pressure was adjusted into a value shown in Table 2 described below. In the case of Examples 3 to 9, and Comparative Examples 2 and 3, the density of a green compact just after the molding step was adjusted into a value shown in Table 2 described below by changing the mass of a fine powder supplied into a mold, and the molding pressure. In the case of Examples 3 to 9, and Comparative Examples 2 and 3, the density of the green compact just before the sintering step was substantially the same as that (density 1) of the green compact just after the molding step. The green compact and the rare earth magnet of each of Examples 3 to 9, and Comparative Examples 2 and 3 were produced in the same way as in Example 2 except that the above-mentioned matters.

The residual magnetic flux density Br of the rare earth magnet of each of Examples 3 to 9, and Comparative Examples 2 and 3 was measured in the same way as in Example 2. The residual magnetic flux density Br of the rare earth magnet of each of Examples 3 to 9, and Comparative Examples 2 and 3 is shown in Table 2 described below.

The coercivity HcJ of the rare earth magnet of each of Examples 3 to 9, and Comparative Examples 2 and 3 was measured in the same way as in Example 2. The coercivity HcJ of the rare earth magnet of each of Examples 3 to 9, and Comparative Examples 2 and 3 is shown in Table 2 described below.

The crack generation rate of each of Examples 3 to 9, and Comparative Examples 2 and 3 was measured in the same way as in Example 2. The crack generation rate of each of Examples 3 to 9, and Comparative Examples 2 and 3 is shown in Table 2 described below.

### Comparative Examples 4 to 6

In the case of Comparative Examples 4 to 6, the green compact was not heated to 300° C. between the orientation step and the sintering step. In the case of Comparative Examples 4 to 6, the green compact was transferred from the above-mentioned mold into another rubber mold after the orientation step. The rubber mold containing the green compact was set in water, and the green compact in the rubber mold was compressed isotropically by water pressure. As described above, in the case of Comparative Examples 4 to 6, cold isostatic pressing was conducted instead of the heating at 300° C. The cold isostatic pressing is represented by “CIP” in Table 2 described below. The water pressure in the cold isostatic pressing was adjusted into a value shown in Table 2 described below. The green compact was separated from the rubber mold to be placed on the tray for sintering after the cold isostatic pressing.

The green compact and the rare earth magnet of each of Comparative Examples 4 to 6 were produced in the same way as in Example 2 except the above-mentioned matters. The density of the green compact of each of Comparative Examples 4 to 6 just after the cold isostatic pressing was adjusted into a value shown in Table 2 described below. The density of each of the green compacts just after the cold isostatic pressing is represented by “Density 2” in Table 2 described below. The density of the green compact after the cold isostatic pressing of each of Comparative Examples 4 to 6 corresponds to the density of the green compact just before the sintering step of each of Comparative Examples 4 to 6.

The residual magnetic flux density Br of the rare earth magnet of each of Comparative Examples 4 to 6 was measured in the same way in Example 2. The residual magnetic flux density Br of the rare earth magnet of each of Comparative Examples 4 to 6 is shown in Table 2 described below.

The coercivity HcJ of the rare earth magnet of each of Comparative Examples 4 to 6 was measured in the same way in Example 2. The coercivity HcJ of the rare earth magnet of each of Comparative Examples 4 to 6 is shown in Table 2 described below.

The crack generation rate of each of Comparative Examples 4 to 6 was measured in the same way in Example 2. The crack generation rate of each of Comparative Examples 4 to 6 is shown in Table 2 described below.

TABLE 2

| | | | | Water | | Residual | | |
|---|---|---|---|---|---|---|---|---|
| | Molding | | | pressure | | magnetic flux | Coercivity | Crack |
| | pressure | Density 1 | | in CIP | Density 2 | density Br | HcJ | generation |
| | (MPa) | (g/cm³) | CIP | (MPa) | (g/cm³) | (kG) | (kOe) | rate |
| Comparative | 0.10 | 2.8 | Not done | — | — | 13.36 | 14.58 | 30% |
| Example 2 | | | | | | | | |
| Example 2 | 0.11 | 3.0 | Not done | — | — | 13.92 | 14.13 | 20% |
| Example 3 | 0.12 | 3.2 | Not done | — | — | 14.26 | 13.89 | 10% |
| Example 4 | 0.13 | 3.4 | Not done | — | — | 14.57 | 13.84 | 0% |
| Example 5 | 0.14 | 3.6 | Not done | — | — | 14.57 | 14.23 | 0% |
| Example 6 | 0.29 | 3.8 | Not done | — | — | 14.55 | 14.61 | 0% |
| Example 7 | 0.71 | 4.0 | Not done | — | — | 14.07 | 15.45 | 0% |
| Example 8 | 1.0 | 4.2 | Not done | — | — | 13.77 | 15.62 | 0% |
| Example 9 | 4.3 | 4.4 | Not done | — | — | 13.31 | 16.22 | 0% |
| Comparative | 5.4 | 4.6 | Not done | — | — | 12.61 | 16.49 | 10% |
| Example 3 | | | | | | | | |
| Comparative | 0.14 | 3.6 | Done | 90 | 4.5 | 14.37 | 14.24 | 90% |
| Example 4 | | | | | | | | |
| Comparative | 0.14 | 3.6 | Done | 100 | 4.6 | 14.39 | 14.26 | 100% |
| Example 5 | | | | | | | | |
| Comparative | 0.14 | 3.6 | Done | 130 | 4.7 | 14.34 | 14.18 | 100% |
| Example 6 | | | | | | | | |

As shown in Table 2, in the case of Examples 2 to 9, the density of the green compact to be sintered in the sintering step was adjusted to 3.0 g/cm³ or more and 4.4 g/cm³ or less. As a result, the residual magnetic flux density Br of each of Examples 2 to 9 was 13 kG or more, and the crack generation rate of each of Examples 2 to 9 was 20% or less.

The crack generation rate of Comparative Example 2 was higher than that of each of all the examples. It is presumed that cracks of Comparative Example 2 resulted from the matter that the green compact of Comparative Example 2 was inferior to those of all the examples in mechanical strength (shape retaining ability) owing to the excessively low molding pressure of Comparative Example 2.

The residual magnetic flux density Br of Comparative Example 3 was lower in than those of all the examples. It is presumed that the low residual magnetic flux density Br of Comparative Example 3 resulted from the matter that the excessively high molding pressure of Comparative Example 3 made the fine powder particles (alloy powder particles) in the mold difficult to rotate freely and to be oriented along the magnetic field. It is presumed that the cracks of Comparative Example 3 resulted from the matter that a spring-back of the green compact was caused by the excessively high molding pressure of Comparative Example 3.

The crack generation rates of Comparative Examples 4 to 6 were remarkably higher than those of all the examples. It is presumed that the high crack generation rates of Comparative Examples 4 to 6 resulted from the matter that the spring-back of the green compact was caused by excessively high water pressure in the CIP. It is presumed that the high residual magnetic flux densities Br of Comparative Examples 4 to 6 resulted from the matter that the orientation of the fine powder (alloy powder) before the shrinking was kept when the green compact was shrunken isotropically by the CIP.

### INDUSTRIAL APPLICABILITY

The method for producing a rare earth magnet according to the present invention makes it possible to produce a wide variety of rare earth magnets, correspondingly to various applications such as hard disc drives, hybrid vehicles, or electric vehicles. Thus, costs for the production can be reduced even when the production quantity thereof is small.

### REFERENCE SIGNS LIST

2 Mold
4 Upper mold
6 Side mold
8 Lower mold
10 Green compact
12 Air-core coil
H Pulse magnetic field

1: A method for producing a rare earth magnet, the method comprising:
a molding step of supplying a metal powder containing a rare earth element into a mold to form a green compact;
an orientation step of applying a pulse magnetic field to the green compact held in the mold to orient the metal powder included in the green compact; and
a sintering step of sintering the green compact separated from the mold after the orientation step,
wherein at least one part of the mold is formed from a resin, and
the green compact having a density adjusted to 3.0 g/cm³ or more and 4.4 g/cm³ or less is sintered.

2: The method for producing a rare earth magnet according to claim 1,
wherein the mold includes a lower mold, a cylindrical side mold to be disposed on the lower mold, and an upper mold to be inserted into the side mold from above the side mold, and
out of the lower mold, the side mold and the upper mold, at least the side mold is formed from the resin.

3: The method for producing a rare earth magnet according to claim 1,
wherein the resin is an insulating resin.

4: The method for producing a rare earth magnet according to claim 1,
wherein a pressure exerted on the metal powder by the mold is adjusted to 0.049 MPa or more and 20 MPa or less.

5: The method for producing a rare earth magnet according to claim 1,
wherein in the orientation step, the pulse magnetic field is applied to the green compact, using at least two coils arranged to have the same central axis.
